(19) United States
(12) Patent Application Publication
(10) Pub. No.: US 2020/0086628 A1
(43) Pub. Date: Mar. 19, 2020

(54) INK CUP LINED WITH NON-STICK COATING

(71) Applicant: James Cheng, Poway, CA (US)

(72) Inventor: James Cheng, Poway, CA (US)

(21) Appl. No.: 14/450,255

(22) Filed: Aug. 3, 2014

Related U.S. Application Data
(63) Continuation-in-part of application No. 13/363,354, filed on Jan. 31, 2012, now abandoned.

(51) Int. Cl. B41F 31/06

(52) U.S. Cl. CPC B41F 31/06

(57) ABSTRACT

An improvement to the present ink cup technology is presented, resulting in reduced clean-up time, by measurement at least three times faster producing a significant reduction in labor cost. Exposure by employees to high-VOC solvents and emulsifiers is eliminated, and low-VOC solvents mixed with water can be used. This is a significant saving in environmental damage and disposal costs.

### RELATED APPLICATIONS

This application is a Continuation-in-Part of U.S. patent application Ser. No. 13/363,354, filed on Jan. 31, 2012, which is currently co-pending.

### FIELD OF THE INVENTION

This invention relates to improvements in the printing process involving reduction of clean-up time for ink reservoirs, minimizing environmental damage from volatile solvents.

### BACKGROUND OF THE INVENTION

Ink cups (also known as but not limited to reservoirs, chambers, vessels, cartridges ink wells, etc.) are used in pad printing and other applications to bring ink to the printing plate surface and the artwork image area. The liquid ink inside the cup is mixed with a volatile solvent, which evaporates at a predictable rate of speed. In the present technology, the ink cup is filled with ink. After use, the ink cup is emptied and cleaned, to be re-used later. This clean-up process involves immersing said ink cup in a solvent or emulsifier, with potentially high Volatile Organic Compound (VOC) content. The ink cup is then wiped down and stored or reused.

The clean-up process is time consuming, involving fifteen minutes to half and hour of employee time for each complete cleanup. Because of the environmental hazard of using high VOC cleaning fluids, gloves have to be worn and the area has to be ventilated.

The present technology involves significant environmental impact and a moderate amount of labor cost, especially for multiple ink cup cleanings. A method of reducing the exposure of cleaning solutions to the air and evaporation of high-VOC solvents is needed.

### SUMMARY OF THE INVENTION

The present invention consists of a modified ink cup with TEFLON®-coated interior and exterior surfaces. The ink cup would be sprayed with a solution of Teflon® and the coating baked to a hard finish at or around 500 degrees Fahrenheit.

The TEFLON® coating causes the ink to bead up and drain such that the ink residue can be easily removed by rinsing and with wiping or a quick water flush. A low-VOC, green solvent, mixed with water, is all that is necessary to clean the cup interior.

### BRIEF DESCRIPTION OF THE DRAWINGS

FIG. 1. Ink Cup With TEFLON® Spray Coating

FIG. 2. Coated Ink Cup with Ink Residue

### DETAILED SPECIFICATION

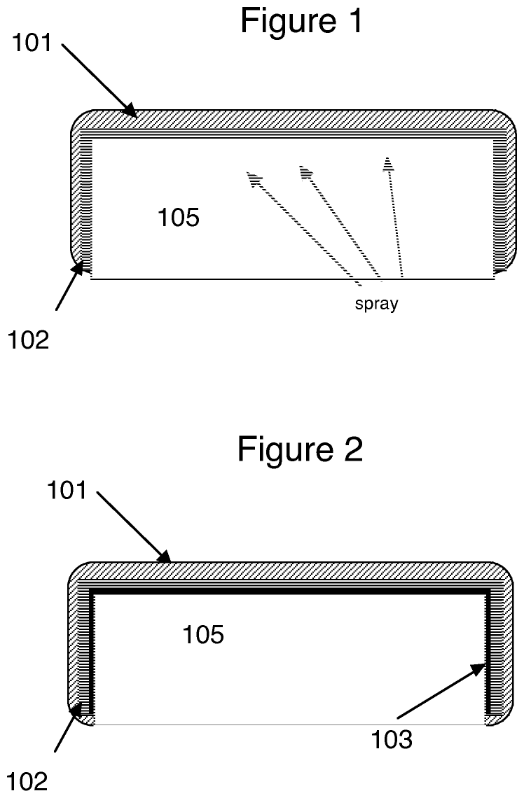

FIG. 1 illustrates the interior cavity 105 of the ink cup 101 being sprayed with a TEFLON® coating 102. The thickness of the coating 102 is exaggerated. This coating is baked onto the ink cup 101 at approximately 500 degrees Fahrenheit until the finish is hard and smooth.

In FIG. 2, the concept of the present invention is shown. The TEFLON® coating 102 causes ink 103 to bead near the surface and drain, so that after the ink cup has been emptied, the ink 103 can be easily wiped away or removed with a gentle, low-VOC solvent. The present state-of-the-art with an uncoated cup requires more extensive clean-up with high-VOC solvents that require the use of gloves and a ventilated area.

The ink cup 101 can be made with any material that is rigid and that stands up to the baking temperature. Aluminum is the preferred embodiment for the current ink cup. Because aluminum is porous to most fluids, an aluminum ink cup 101 would normally trap ink in the pores of its interior surface. Hence, the coating 102 seals these pores and presents a smooth, non-porous interior surface to ink 103 stored in the ink cup 101.

The TEFLON® coating 102 possesses a low coefficient of friction

In the preferred embodiment, the TEFLON® coating is selected as 958-203 TEFLON® FEP for its spray-able characteristics, but other TEFLON® and other non-stick coatings can be used. TEFLON® FEP possesses a low coefficient of static friction ranging from 0.12 to 0.2, which will allow ink 103 to bead up on the sprayed interior surface 102 of the cup 101 and slide off due to the force of gravity, if nothing else. These values are from the Physics Factbook, edited by Glenn Elert.

Since surfaces coated with Teflon® coatings are both oleophobic and hydrophobic, they are not readily wetted. Cleanup is easier and more thorough—in many cases, surfaces are self-cleaning. The improvement to the present technology results in reduced clean-up time, by measurement at least three times faster. This is a significant reduction in labor cost. Low-VOC solvents mixed with water can be used and therefore exposure by employees to high-VOC solvents and emulsifiers is eliminated. This is a significant saving in environmental damage and disposal costs.

This invention has other applications, potentially, and one skilled in the art could discover these. The explication of the features of this invention does not limit the claims of this application; other applications developed by those skilled in the art will be included in this invention.

What is claimed is:

1. An ink cup, the ink cup having a concave shape, the concave shape possessing an external and an internal surface,
the ink cup comprised of a rigid material such that the internal surface is porous to ink,
the internal surface of said ink cup is covered with a uniform thickness of a non-stick coating, the coating is sprayed and then baked onto the ink cup internal surface at approximately 500 degrees Fahrenheit, the baked non-stick coating possessing a non-porous surface with a low coefficient of friction such that vertical sections of said internal surface shed ink due to the force of gravity,
the baked internal surface coating is water proof, washable and resistant to low-VOC solvent.

2. The ink cup of claim 1 where the rigid material is aluminum and the non-stick coating is spray-able 958-203 TEFLON®.

3. A method of using the ink cup of claim 2 comprised of the steps of
obtaining said ink cup,
filling the ink cup with ink,
using the ink cup in a printing process,
cleaning the ink cup with water or water mixed with low Volatile Organic Compound (VOC) solvents,
reusing the ink cup as in this method.
